(19) United States
(12) Patent Application Publication
(10) Pub. No.: US 2011/0102422 A1
(43) Pub. Date: May 5, 2011

(54) TWO-DIMENSIONAL/THREE-DIMENSIONAL IMAGE DISPLAY APPARATUS AND METHOD OF DRIVING THE SAME

(75) Inventors: Sang-moo PARK, Yongin-si (KR); Jong-hoon JUNG, Suwon-si (KR); Dae-sik KIM, Hwaseong-si (KR)

(73) Assignee: Samsung Electronics Co., Ltd., Suwon-si (KR)

(21) Appl. No.: 12/907,400

(22) Filed: Oct. 19, 2010

Related U.S. Application Data
(60) Provisional application No. 61/256,358, filed on Oct. 30, 2009.

(30) Foreign Application Priority Data
Dec. 31, 2009 (KR) 10-2009-0136219

(51) Int. Cl. G06T 15/00

(52) U.S. Cl. 345/419

(57) ABSTRACT

A display apparatus which displays two-dimensional (2D) and three-dimensional (3D) images and a method of driving the same. In the 2D/3D image display apparatus, an image signal input unit inputs, to a display panel, a left image signal, a left inversion image signal, at least one 2D image signal, a right image signal and a right inversion image signal, a left shutter of shutter glasses is open in synchronization with the left image signal, a right shutter of the shutter glasses is open in synchronization with the right image signal, and the left shutter and the right shutter of the shutter glasses are closed in synchronization with the left inversion image signal, the at least one 2D image signal, and the right inversion image signal.

### CROSS-REFERENCE TO RELATED PATENT APPLICATIONS

This application claims the benefit of U.S. Provisional Patent Application No. 61/256,358, filed on Oct. 30, 2009, in the U.S. Patent and Trademark Office, and the benefit of Korean Patent Application No. 10-2009-0136219, filed on Dec. 31, 2009, in the Korean Intellectual Property Office, the disclosures of which are incorporated herein in their entirety by reference.

### BACKGROUND OF THE INVENTION

1. Field

Apparatuses and methods consistent with exemplary embodiments relate to a two-dimensional (2D)/three-dimensional (3D) image display apparatus and a method of driving the same.

2. Description of the Related Art

In general, a 3D image is formed due to the stereoscopic vision of human eyes. Binocular parallax due to the separation of human eyes by about 65 mm is regarded as the most important factor in a 3D effect. A 3D effect may be realized by showing a different view image to each eye. For this, images are captured by using two cameras separated apart from each other by a distance equivalent to a typical distance between eyes, and an image captured by a left camera is shown to only a left eye and an image captured by a right camera is shown to only a right eye.

3D image display apparatuses may use stereoscopic methods or autostereoscopic methods. Stereoscopic methods may include a polarization glass method, a shutter glasses method, among others, and autostereoscopic methods may include a parallax barrier method, a lenticular method, an integral imaging method, and a holography method, among others.

From among the stereoscopic methods, the shutter glasses method may be a liquid crystal shutter glasses method of realizing a 3D image by using glasses having liquid crystal shutters, i.e., liquid crystal shutter glasses. In the liquid crystal shutter glasses method, different images are separately shown to left and right eyes in frequency periods of 60 Hz. A 3D image display apparatus using a liquid crystal shutter glasses method alternately displays left and right images and alternately opens or closes left and right liquid crystal shutters in synchronization with the displayed left and right images.

In a stereoscopic 3D display method, only a 3D image is displayed and thus a viewer who wears shutter glasses may experience a 3D effect. However, a viewer who does not wear shutter glasses will view both the right and left eye images and thus maybe inconvenienced. Accordingly, use of the stereoscopic 3D display method is restrictive.

### SUMMARY

According to an aspect of an exemplary embodiment, there is provided a 2D/3D display apparatus including a display panel which displays an image; an image signal input unit which inputs, to the display panel, a left image signal, a left inversion image signal, a first 2D image signal, a right image signal and a right inversion image signal; a backlight unit which provides light to the display panel; and a shutter controller which controls a left shutter and a right shutter of shutter glasses, such that the left shutter is opened in synchronization with the left image signal, the right shutter is opened in synchronization with the right image signal, and the left shutter and the right shutter are closed in synchronization with the left inversion image signal, the first 2D image signal, and the right inversion image signal.

The display panel may display a first grey level image including a combination of a first image formed due to the left image signal and a second image formed due to the left inversion image signal, and the display panel may display a second grey level image including a third image formed due to the right image signal and a fourth image formed due to the right inversion image signal.

The image signal input unit may further input a second 2D image signal after the right inversion image signal is input.

The image signal input unit may further input at least one black image signal.

The backlight unit may include a plurality of light sources divided among a plurality of blocks arranged in a scanning direction of the image signals and light sources in the plurality of the blocks may be sequentially turned on in block units.

An overall turn-on frequency of the backlight unit may be the same as a refresh rate of the display panel.

An image formed by the first 2D image signal may correspond to a 3D image formed due to the left image signal and the right image signal.

An image formed by the first 2D image signal may be different from a 3D image formed due to the left image signal and the right image signal.

According to an aspect of another exemplary embodiment, there is provided a method of driving a two-dimensional (2D)/three-dimensional (3D) display apparatus, the method including inputting, to a display panel, a left image signal, a left inversion image signal, a first 2D image signal, a right image signal and a right inversion image signal; illuminating the display panel by using a backlight unit; displaying, on the display panel, a first grey level image comprising a combination of a first image formed due to the left image signal and a second image formed due to the left inversion image signal; displaying, on the display panel, a 2D image formed due to the first 2D image signal; displaying, on the display panel, a second grey level image comprising a combination of a third image formed due to the right image signal and a fourth image formed due to the right inversion image signal; and opening a left shutter of shutter glasses in synchronization with the left image signal, opening a right shutter of the shutter glasses in synchronization with the right image signal, and closing the left shutter and the right shutter of the shutter glasses in synchronization with the left inversion image signal, the first 2D image signal, and the right inversion image signal.

### BRIEF DESCRIPTION OF THE DRAWINGS

The above and other aspects will become more apparent by describing in detail exemplary embodiments with reference to the attached drawings in which:

FIG. 1 is a schematic diagram of a 2D/3D image display apparatus according to an exemplary embodiment;

FIG. 2 is a diagram showing image signals input to the 2D/3D image display apparatus illustrated in FIG. 1, according to an exemplary embodiment;

FIG. 3 is a diagram for describing a method of driving the 2D/3D image display apparatus illustrated in FIG. 1 based on the image signals illustrated in FIG. 2, according to an exemplary embodiment;

FIG. 4 is a schematic diagram of a backlight unit of the 2D/3D image display apparatus illustrated in FIG. 1, according to an exemplary embodiment;

FIG. 5 is a diagram for describing a method of driving the 2D/3D image display apparatus illustrated in FIG. 1 based on the image signals illustrated in FIG. 2, according to another exemplary embodiment;

FIG. 6 is a diagram showing image signals input to the 2D/3D image display apparatus illustrated in FIG. 1, according to another exemplary embodiment;

FIG. 7 is a diagram for describing a method of driving the 2D/3D image display apparatus illustrated in FIG. 1 based on the image signals illustrated in FIG. 6, according to an exemplary embodiment; and

FIG. 8 is a diagram for describing a method of driving the 2D/3D image display apparatus illustrated in FIG. 1 based on the image signals illustrated in FIG. 6, according to another exemplary embodiment.

### DETAILED DESCRIPTION OF EXEMPLARY EMBODIMENTS

Hereinafter, the present invention will be described in detail by explaining exemplary embodiments with reference to the attached drawings.

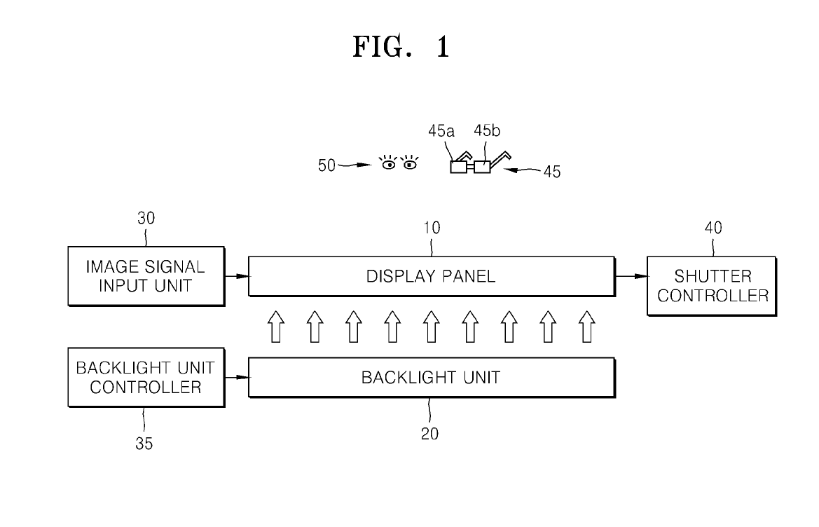

FIG. 1 is a schematic diagram of a 2D/3D image display apparatus according to an exemplary embodiment. The 2D/3D image display apparatus according to this exemplary embodiment includes a display panel 10 for displaying an image, a backlight unit 20 for providing light to the display panel 10, and an image signal input unit 30 for inputting an image signal to the display panel 10.

The display panel 10 may include, for example, a liquid crystal panel. The liquid crystal panel includes pixel units, each including a thin film transistor (TFT) and an electrode, and displays an image by applying an electric field to the pixel units of the liquid crystal panel according to the image signal input from the image signal input unit 30 so as to modulate the light provided from the backlight unit 20.

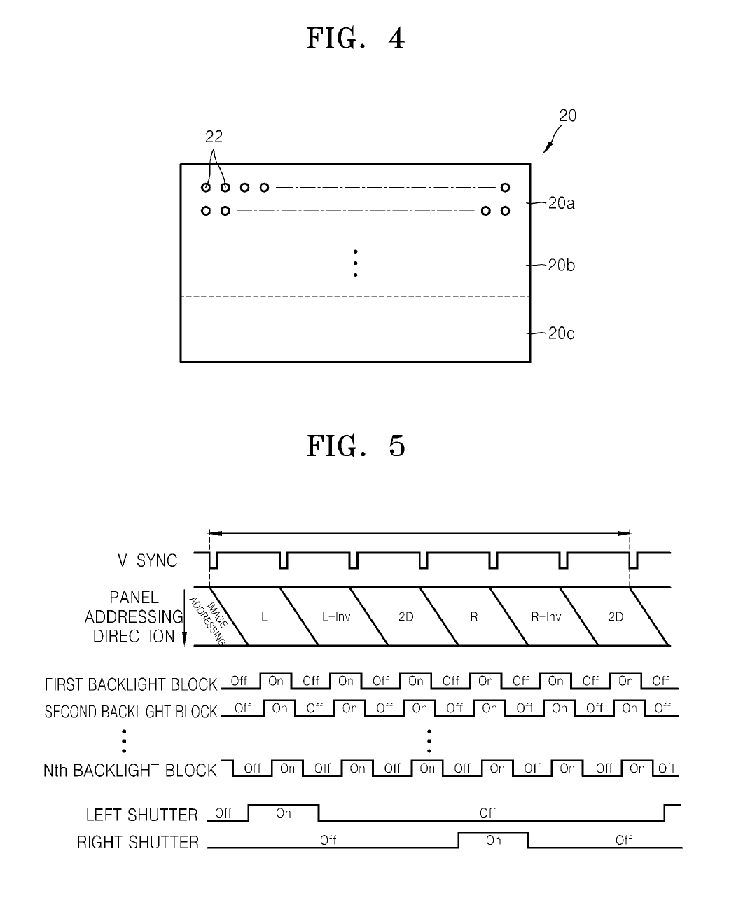

The backlight unit 20 may include light emitting elements 22 (see FIG. 4) and a backlight unit controller 35 for controlling the light emitting elements 22. The light emitting elements 22 may include, for example, cold cathode fluorescent lamps (CCFLs) or light emitting diodes (LEDs).

The image signal input unit 30 may output a 2D image signal, a 3D image signal, and an inversion image signal. The inversion image signal is for forming a predetermined gray level image by being mixed with an image formed due to the 3D image signal. For example, the 3D image signal may include a left image signal and a right image signal, and the inversion image signal may include a left inversion image signal and a right inversion image signal.

The 2D/3D image display apparatus according to this exemplary embodiment may enable a 3D image and a 2D image to be viewed at the same time by different viewers. For example, a 3D image may be viewed by using shutter glasses 45 and a 2D image may be viewed with naked eyes 50. As a shutter controller 40 opens a left shutter 45a of the shutter glasses 45 and closes a right shutter 45b of the shutter glasses 45 in synchronization with a left image signal, and closes the left shutter 45a and opens the right shutter 45b in synchronization with a right image signal, a 3D image may be displayed to a viewer wearing the shutter glasses 45. Meanwhile, a viewer who does not wear the shutter glasses 45 may view a 2D image displayed due to a 2D image signal. In this case, the viewer who does not wear the shutter glasses 45 will not recognize original data of a 3D image because an image formed due to a 3D image signal is mixed with an image formed due to a 3D inversion image signal. An inversion image may include an image on which gray level inversion and/or color reversing are performed. Gray level inversion may include, for example, inversion from a bright image into a dark image. Color reversing may include conversion of image colors into complementary colors. For example, red may be inverted into cyan (green+blue), green may be inverted into magenta (red+blue), and blue may be inverted into yellow (red+green). If an inversion image and an original image are subsequently viewed, the original image may not be recognized in favor of a gray level image which is a mixture of the inversion image and the original image.

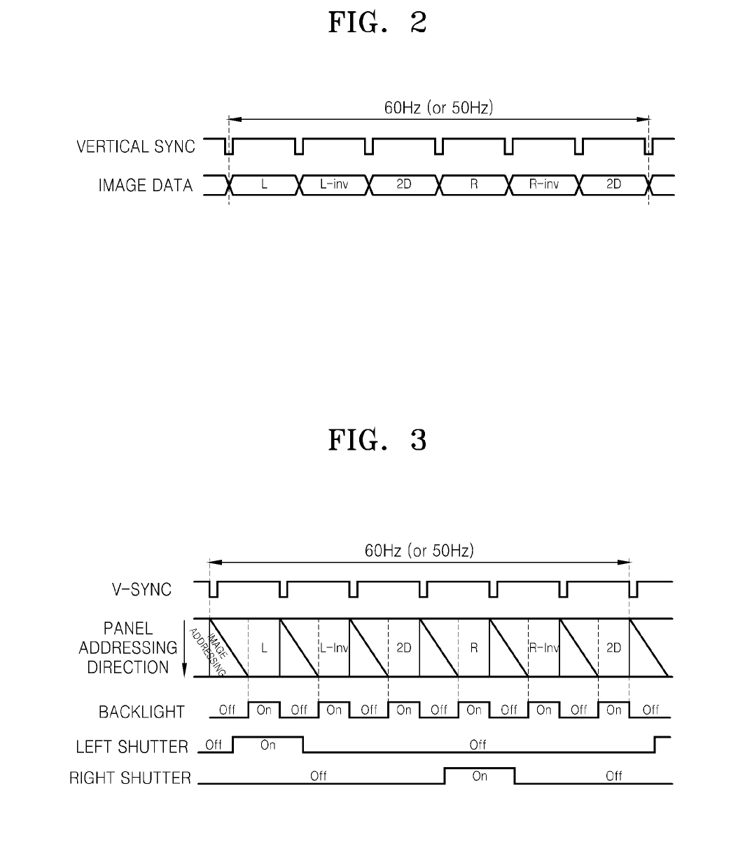

FIG. 2 is a diagram showing image signals input to the 2D/3D image display apparatus illustrated in FIG. 1, according to an exemplary embodiment.

Referring to FIG. 2, the image signal input unit 30 may output, for example, a left image signal L, a left inversion image signal L-inv, at least one 2D image signal 2D, a right image signal R and a right inversion image signal R-inv. The image signals may be input to the display panel 10 in synchronization with a vertical synchronization signal, Vertical Sync. The display panel 10 may have, for example, a frame frequency of 60 Hz or 50 Hz. Here, a frame frequency may represent the speed of a cycle for displaying a 3D image and a 2D image together. For example, one 3D image formed due to a left image and a right image and a 2D image may be displayed for 1/60 sec. or 1/50 sec. FIG. 5 shows an example when, for example, a 3D image, a first 2D image and a second 2D image are displayed in one cycle. The second 2D image may be identical to the first 2D image. As two 2D images are displayed during a single cycle, the quality of a 2D image may be increased. Alternatively, the second 2D image may be different from first 2D image. In this case, the frame frequency of a 2D image is increased.

The speed of scanning by the display panel 10 of image signals input during one cycle is a refresh rate. For example, when the display panel 10 has a frame frequency (or a frame rate) of 60 Hz or 50 Hz and the image signals in one cycle include a left image signal L, a left inversion image signal L-inv, a first 2D image signal 2D, a right image signal R, a right inversion image signal R-inv and a second 2D image signal 2D, each of the image signals may have a refresh rate of 360 Hz or 300 Hz. The frame rate and the refresh rate are not limited thereto and may be variously changed in consideration of desired image texture or the like. Also, an input order of the image signals is not limited to the order illustrated in FIG. 2.

FIG. 3 is a diagram for describing a method of driving the 2D/3D image display apparatus illustrated in FIG. 1 based on the image signals illustrated in FIG. 2, according to an exemplary embodiment. In FIG. 3, the backlight unit 20 and the shutter glasses 45 are driven based on the image signals. When the left image signal L is input to the display panel 10, the backlight unit 20 is entirely switched on, the left shutter 45a of the shutter glasses 45 is open, and the right shutter 45b of the shutter glasses 45 is closed. For example, when a liquid crystal panel is used as the display panel 10, a liquid crystal operation time may include a rising time taken to turn on the liquid crystal panel according to an input signal, a time taken to maintain the on state of the liquid crystal panel, and a falling time taken to completely turn off the liquid crystal panel. The backlight unit 20 may provide light only in periods when the liquid crystal panel is maintained in the on state. Accordingly, the backlight unit 20 may be turned off during the rising time after a data signal is input, may be turned on while the liquid crystal panel is maintained in the on state, and may be turned off during the falling time. The backlight unit 20 may be controlled by the backlight unit controller 35.

Then, when the left inversion image signal L-inv is input to the display panel 10, the backlight unit 20 is entirely switched on, and the left shutter 45a and the right shutter 45b of the shutter glasses 45 are closed. When the 2D image signal 2D is input to the display panel 10, the backlight unit 20 is entirely switched on, and the left shutter 45a and the right shutter 45b of the shutter glasses 45 are closed. When the right image signal R is input to the display panel 10, the backlight unit 20 is entirely switched on, the left shutter 45a of the shutter glasses 45 is closed, and the right shutter 45b of the shutter glasses 45 is open. When the right inversion image signal R-inv is input to the display panel 10, the backlight unit 20 is entirely switched on, and the left shutter 45a and the right shutter 45b of the shutter glasses 45 are closed. When the last 2D image signal 2D is input to the display panel 10, as described above, the backlight unit 20 is entirely switched on, and the left shutter 45a and the right shutter 45b of the shutter glasses 45 are closed.

A viewer does not independently identify each of images displayed in one cycle of, for example, 1/60 sec. or 1/50 sec., but views the images as one mixed image. A viewer who wears the shutter glasses 45 may view a stereoscopic image as a left image and a right image which are separately and respectively viewed by left and right eyes according to the opening and closing of the shutter glasses 45, and does not recognize the cut-off of the other images as long as a frame rate is within a predetermined range. A viewer who does not wear the shutter glasses 45 may view a monoscopic image in which a 2D image is mixed with a gray level background formed as the left image and the left inversion image are mixed and the right image and the right inversion image are mixed. As such, the 2D/3D image display apparatus according to the current exemplary embodiment may enable a 2D image and a 3D image to be viewed at the same time by different viewers. The viewer who does not wear the shutter glasses 45 may also view a 2D image without experiencing eye fatigue. Accordingly, a viewer who experiences eye fatigue or wants to view a 2D image after viewing a 3D image for a long time may take off the shutter glasses 45 and may view the 2D image. That is, a viewer may choose to view one of a 2D image and a 3D image, and a plurality of viewers may view a 2D image and a 3D image together according to their own choices.

The 2D image signal 2D may include an image signal having no disparity to the 3D image formed due to the left image signal L and the right image signal R. In this case, the same image may be viewed as a 3D image or a 2D image.

Alternately, the 2D image signal 2D may include an image signal independent from the 3D image formed due to the left image signal L and the right image signal R. In this case, the 3D image and the 2D image are different from each other and two different channels may be displayed on one screen.

Further, instead of being entirely turned on or off, the backlight unit 20 may be divided into a plurality of blocks and light sources of the blocks may be sequentially driven in block units. For example, the backlight unit 20 may be divided into N blocks in a scanning direction of the display panel 10 and the n blocks of the backlight unit 20 may be sequentially turned on in synchronization with image addressing. A block of the backlight unit 20 may represent a region where a plurality of light sources are controlled together. For example, referring to FIG. 4, the backlight unit 20 may include a plurality of light sources 22 and first through third backlight blocks 20a through 20c. When the light sources 22 of the backlight unit 20 are turned on, the light sources 22 in the first backlight block 20a may be turned on, the light sources 22 in the second backlight block 20b may be turned on, and then the light sources 22 in the third backlight block 20c may be turned on. When the light sources 22 of the second backlight block 20b are turned on, the light sources 22 of the first backlight block 20a do not need to be turned off. A turn-on maintenance time of the light sources 22 in each of the first through third backlight blocks 20a through 20c may be variously adjusted in consideration of, for example, a response speed or a frame rate of the display panel 10. As the light sources 22 in the plurality of backlight blocks 20a through 20c are sequentially driven, the time for providing light to the display panel 10 may be increased to improve luminance, and crosstalk caused by a low response speed of the display panel 10, may be reduced.

FIG. 5 is a diagram for describing a method of driving the 2D/3D image display apparatus illustrated in FIG. 1 based on the image signals illustrated in FIG. 2, according to another exemplary embodiment. In FIG. 5, light sources in first through Nth backlight blocks are sequentially turned on.

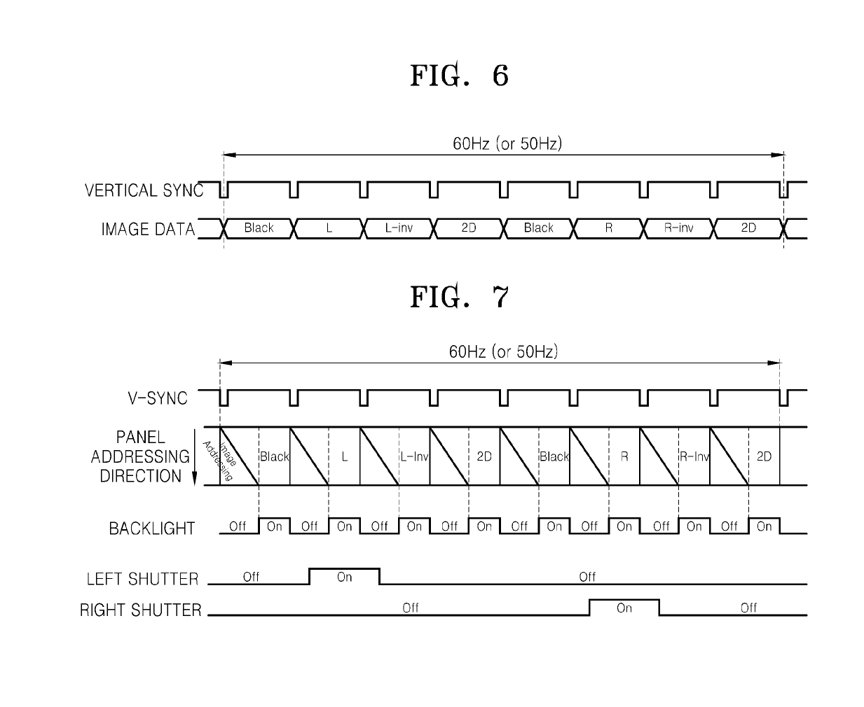

FIG. 6 is a diagram showing image signals input to the 2D/3D image display apparatus illustrated in FIG. 1, according to another exemplary embodiment.

Referring to FIG. 6, the image signal input unit 30 may include a black image signal Black, a left image signal L, a left inversion image signal L-inv, a 2D image signal 2D, a black image signal Black, a right image signal, a right inversion image signal R-inv and a 2D image signal 2D. In FIG. 6, as the black images Black are further included, crosstalk caused by a low response speed of the display panel 10 may be reduced. Images in one cycle are referred to as one frame and each of the images included in one frame is referred to as a sub image frame, and a scanning speed corresponding to each sub image frame is referred to as a refresh rate. For example, when a frequency of one frame is 60 Hz or 50 Hz and one frame includes eight sub image frames, a refresh rate of each sub image frame may be 480 Hz or 400 Hz.

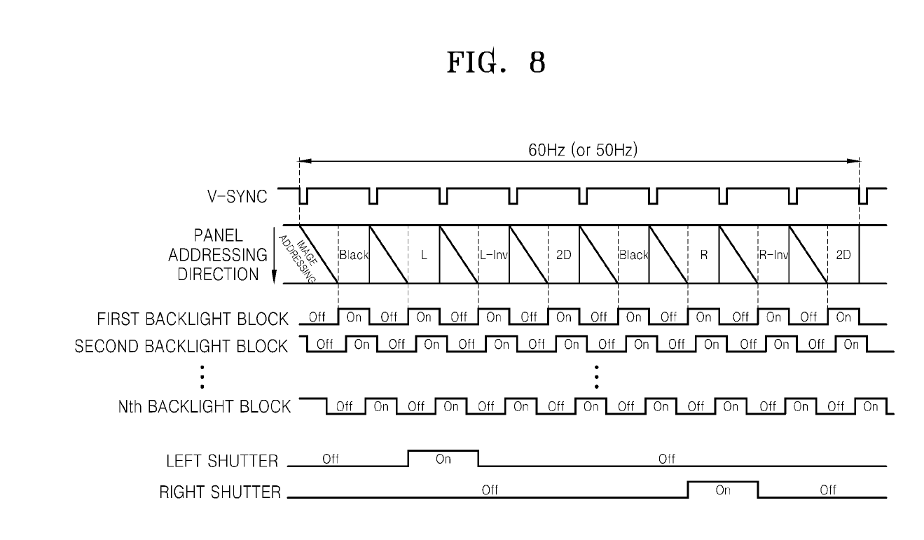

FIG. 7 is a diagram for describing a method of driving the 2D/3D image display apparatus illustrated in FIG. 1 based on the image signals illustrated in FIG. 6, according to an exemplary embodiment.

Referring to FIG. 7, the left shutter 45a of the shutter glasses 45 is open and the right shutter 45b of the shutter glasses 45 is closed in synchronization with the left image signal L, the left shutter 45a is closed and the right shutter 45b is open in synchronization with the right image signal R, and the shutter glasses 45 are closed in synchronization with the other image signals. As such, a viewer who wears the shutter glasses 45 may view a 3D image formed due to a left image and a right image. A viewer who does not wear the shutter glasses 45 may view a black image and a first 2D image on a gray level background formed due to the left image signal L and left inversion image signal L-inv, and may also view a black image and a second 2D image on a gray level background formed due to the right image signal R and the right inversion image signal R-inv. The second 2D image may be identical to the first 2D image. As a frame frequency of a 2D image is increased by repeatedly displaying the same image, crosstalk may be reduced. The first 2D image and the second 2D image may include images corresponding to the 3D image formed due to the left image signal L and the right image signal R. Alternately, the first 2D image and the second 2D image may include images independent from the 3D image formed due to the left image signal L and the right image signal R.

FIG. 8 is a diagram for describing a method of driving the 2D/3D image display apparatus illustrated in FIG. 1 based on the image signals illustrated in FIG. 6, according to another exemplary embodiment.

In FIG. 8, when one frame includes eight sub frames as illustrated in FIG. 7, the backlight unit 20 is divided into N blocks and light sources 22 (see FIG. 4) in the N blocks are sequentially turned on. The backlight unit controller 35 may control a turn-on cycle and a turn-off cycle of the light sources 22 of each of the N blocks. Here, an overall turn-on frequency of the backlight unit 20 may be the same as a refresh rate of the display panel 10.

In the method according to the current exemplary embodiment, the image signal input unit 30 inputs at least one 2D image signal, a 3D image signal and a 3D inversion image signal to the display panel 10. The image signal input unit 30 may sequentially input to the display panel 10, the left image signal L, the left inversion image signal L-inv, the 2D image signal 2D, the right image signal R and the right inversion image signal R-inv to the display panel 10. The backlight unit 20 provides light to the display panel 10. A first image formed due to the left image signal L and a second image formed due to the left inversion image signal L-inv are displayed, and then a 2D image formed due to the 2D image signal 2D is displayed. Then, a third image formed due to the right image signal R and a fourth image formed due to the right inversion image signal R-inv are displayed. The first image and the second image may be mixed so as to display a gray level image, the third image and the fourth image may be mixed so as to display a gray level image. Thereby, a viewer with the naked eyes 50 who does not wear the shutter glasses 45 may view a 2D image.

Also, the left shutter 45a of the shutter glasses 45 is open in synchronization with the left image signal L, the right shutter 45b of the shutter glasses 45 is open in synchronization with the right image signal R, and the shutter glasses 45 are closed in synchronization with the other image signals, thereby displaying a 3D image.

The exemplary embodiments can be implemented as computer programs that are stored on a computer readable recording medium executed by general-use digital computers. Examples of the computer readable recording medium include magnetic storage media (e.g., ROM, floppy disks, hard disks, etc.), optical recording media (e.g., CD-ROMs, or DVDs), etc.

As described above, according to exemplary embodiments, a stereoscopic 3D image and a 2D image may be viewed at the same time. According to exemplary embodiments, as a 2D image and a 3D image are displayed together, one viewer may view a 3D image by wearing shutter glasses while another viewer may view a 2D image with naked eyes. Accordingly, many viewers may freely view a 2D image and a 3D image at the same time on one display apparatus. Furthermore, as a 2D image and a 3D image may be displayed as independent images, two channels may be displayed on one screen.

While exemplary embodiments have been particularly shown and described, it will be understood by those of ordinary skill in the art that various changes in form and details may be made therein without departing from the spirit and scope of the inventive concept as defined by the following claims.

What is claimed is:

1. A display apparatus which displays two-dimensional (2D) and three-dimensional (3D) images, the display apparatus comprising:
a display panel which displays an image;
an image signal input unit which inputs, to the display panel, a left image signal, a left inversion image signal, a first 2D image signal, a right image signal and a right inversion image signal; and
a shutter controller which controls a left shutter and a right shutter of shutter glasses, so that the left shutter is opened in synchronization with the left image signal, the right shutter is opened in synchronization with the right image signal, and the left shutter and the right shutter are closed in synchronization with the left inversion image signal, the first 2D image signal, and the right inversion image signal.

2. The display apparatus of claim 1, wherein the display panel displays a first grey level image comprising a combination of a first image formed due to the left image signal and a second image formed due to the left inversion image signal, and the display panel displays a second grey level image comprising a combination of a third image formed due to the right image signal and a fourth image formed due to the right inversion image signal.

3. The display apparatus of claim 1, wherein the image signal input unit further inputs, to the display panel, a second 2D image signal after the right inversion image signal is input.

4. The display apparatus of claim 1, wherein the image signal input unit further inputs, to the display panel, at least one black image signal.

5. The display apparatus of claim 1, further comprising a backlight unit which provides light to the display panel and comprises a plurality of light sources divided among a plurality of blocks arranged in a scanning direction of the image signals, and wherein the light sources are sequentially turned on in block units.

6. The display apparatus of claim 5, wherein a turn-on frequency of the backlight unit is the same as a refresh rate of the display panel.

7. The display apparatus of claim 1, wherein an image formed by the first 2D image signal corresponds to a 3D image formed by the left image signal and the right image signal.

8. The display apparatus of claim 1, wherein an image formed by the first 2D image signal is different from a 3D image formed by the left image signal and the right image signal.

9. A method of driving a display apparatus which displays two-dimensional (2D) and three-dimensional (3D) images, the method comprising:
inputting, to a display panel, a left image signal, a left inversion image signal, a first 2D image signal, a right image signal and a right inversion image signal;
displaying, on the display panel, an image comprising a combination of a first image based on the left image signal and a second image based on the left inversion image signal;
displaying, on the display panel, a 2D image formed based on the first 2D image signal;
displaying, on the display panel, an image comprising a combination of a third image formed based on the right image signal and a fourth image formed based on the right inversion image signal; and opening a left shutter of shutter glasses in synchronization with the left image signal, opening a right shutter of the shutter glasses in synchronization with the right image signal, and closing the left shutter and the right shutter of the shutter glasses in synchronization with the left inversion image signal, the first 2D image signal, and the right inversion image signal.

10. The method of claim 9, wherein the image comprising the combination of the first image and the second image comprises a first gray level image that is displayed by the mixing of the first image and the second image, and the image comprising the combination of the third image and the fourth image is a second gray level image that is displayed by the mixing of the third image and the fourth image.

11. The method of claim 9, further comprising inputting, to the display panel, a second 2D image signal after the right inversion image signal is input.

12. The method of claim 9, further comprising inputting, to the display panel, at least one black image signal.

13. The method of claim 9, wherein:
the display apparatus comprises a backlight comprising a plurality of light sources divided among a plurality of blocks arranged in a scanning direction of the image signals; and
the illuminating the display panel comprises sequentially turning on the plurality of light sources in the plurality of the blocks in block units.

14. The method of claim 9, wherein a frame frequency of the display panel is 50 Hz or 60 Hz.

15. The method of claim 9, wherein an image formed by the first 2D image signal corresponds to a 3D image formed by the left image signal and the right image signal.

16. The method of claim 9, wherein an image formed by the first 2D image signal is different from a 3D image formed by the left image signal and the right image signal.

17. The method of claim 9, wherein the image signals are input according to a vertical synchronization signal.

18. A method of driving a display apparatus which displays two-dimensional (2D) and three-dimensional (3D) images, the method comprising:
transmitting an image signal to a display panel, the image signal comprising a repeating series of signals, the series of signals comprising a left image signal, a left inversion image signal, a 2D image signal, a right image signal, and a right inversion image signal;
displaying, on the display panel, a repeating series of images based on the repeating series of signals, the series of images comprising a left image, a left inversion image, a 2D image, a right image, and a right inversion image;
controlling a left shutter and a right shutter of shutter glasses so that the left shutter is open in synchronization with the display of the left image, the right shutter is open in synchronization with the display of the right image, and the left and right shutters are both closed in synchronization with the display of the left inversion image, the 2D image, and the right inversion image;
wherein the left image and the left inversion image together form a first gray level image and the right image and the right inversion image together form a second gray level image, as perceived by a viewer without the shutter glasses.
